(19) United States
(12) Patent Application Publication
(10) Pub. No.: US 2015/0198296 A1
(43) Pub. Date: Jul. 16, 2015

(54) ILLUMINATING BAR OF SOAP

(71) Applicant: Lee Del Rosario, Glendale, CA (US)

(72) Inventor: Lee Del Rosario, Glendale, CA (US)

(21) Appl. No.: 14/323,815

(22) Filed: Jul. 3, 2014

Related U.S. Application Data
(60) Provisional application No. 61/928,272, filed on Jan. 16, 2014.

(51) Int. Cl. F21L 4/00; F21V 33/00; C11D 17/00

(52) U.S. Cl. CPC F21L 4/00; C11D 17/0047; F21V 33/004; F21Y 2101/02

(57) ABSTRACT

An illuminating bar of soap is disclosed that includes a light module and a soap element, wherein the light module is surrounded by the soap element; wherein the light module comprises a sensor and at least one light source; whereas when the sensor senses a change in its surroundings, stability or a combination thereof, such as motion, temperature or light, the sensor triggers the light source to illuminate for a predetermined amount of time.

This United States Utility Application claims the benefit of priority based on Provisional Application Ser. No. 61/928,272 filed on Jan. 16, 2014 and entitled “A motion activated, timed, led illuminated soap bar, designed to teach people of all ages how to wash and sanitize hands”, which is commonly-owned and incorporated in its entirety by reference.

### FIELD OF THE SUBJECT MATTER

The field of the subject matter relates to soap, in particular, a bar of soap that illuminates. The bar of soap senses a change in its surroundings, stability or a combination thereof, such as motion, temperature or light and illuminates for a predetermined length of time depending on the change.

### BACKGROUND

Washing hands properly, especially for children, can be challenging. Individuals, especially children, do not like to wash their hands. Others need to be reminded to wash their hands. Others need to be taught how to wash their hands properly. The lack of proper hand washing often leads to the spread of germs which leads to contamination throughout households, schools, restaurants, hospitals and other public places.

Most individuals are unaware of how to properly wash their hands and fewer know the proper length to do so. According to the Centers for Disease Control and Prevention and US Food and Drug Administration, it is suggested the proper length of time needed to wash hands in avoiding the spread of possible sicknesses is 20 to 30 seconds with soap and warm water. Having a device that makes washing hands interesting and educational would help lessen the spread of germs and effectively avoid the spread of sicknesses and viruses.

Humans are attracted to light and color. Therefore, it would be ideal to provide individuals with visual cues and a visual incentive to engage them (especially children) with the process of washing their hands.

### SUMMARY

An illuminating bar of soap comprising a light module and a soap element; the light module is surrounded by the soap element.

An illuminating bar of soap comprising a light module and a soap element; the light module is surrounded by the soap element; wherein the light module comprises a motion sensor, a circuit board, and at least a single light source; whereas when the sensor senses a change in state, the sensor triggers the at least single light source to illuminate for a predetermined amount of time.

A method of washing hands using an illuminating bar of soap, wherein the illuminating bar of soap comprises a light module surrounded by a soap element; wherein the light module comprises a sensor and at least one light source, the method comprising: triggering the sensor causing the at least one light source to illuminate; illuminating the at least one light source; and washing the user's hands with the illuminating bar of soap, wherein the at least one light source stops illuminating when the user should stop washing the user's hands.

### BRIEF DESCRIPTION OF THE FIGURES

By way of example only, selected embodiments and aspects of a contemplated embodiment are described below. Each such description refers to a particular figure (“FIG.”) which shows the described matter. Each such figure includes one or more reference numbers that identify one or more part(s) or element(s) of the contemplated embodiment.

FIG. 1 shows a contemplated embodiment of the illuminating bar of soap.

FIG. 2 shows a contemplated embodiment of the light module.

FIG. 3 shows a contemplated embodiment of the illuminating bar of soap.

### DETAILED DESCRIPTION

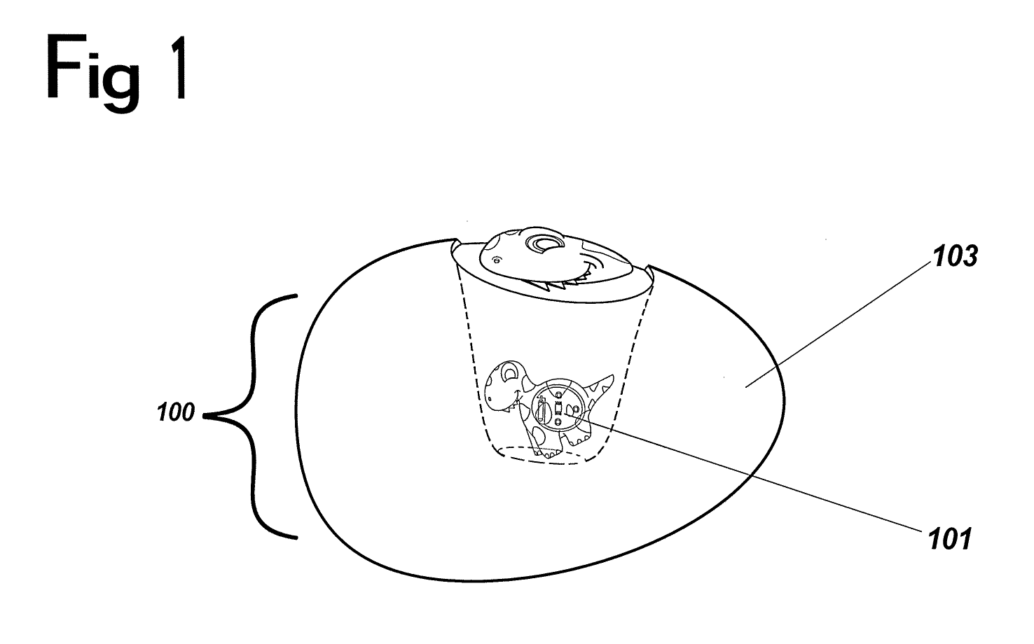

FIG. 1 shows a contemplated embodiment of the illuminating bar of soap 100 with the light module 101 inside it.

As shown in FIG. 1, the light module 101 is surrounded by a soap element 103. The soap element 103 may be manufactured from commonly used ingredients that are used to manufacture soap, including but not limited to vegetable based glycerin, essential oils and colored dyes. In order to form the soap element 103 around the light module 101, the ingredients may be injected or poured into a mold, so that when the ingredients harden, it forms the soap element 103 around the light module 101. The soap element may be formed into the shape of a traditional bar of soap or other shapes such as dinosaurs, animals, cars, boats, action figures and the like. Other ingredients such as mica may be added to help intensify the light emitted. Other ingredients such as UV reactive pigments may be added to create phosphorescence.

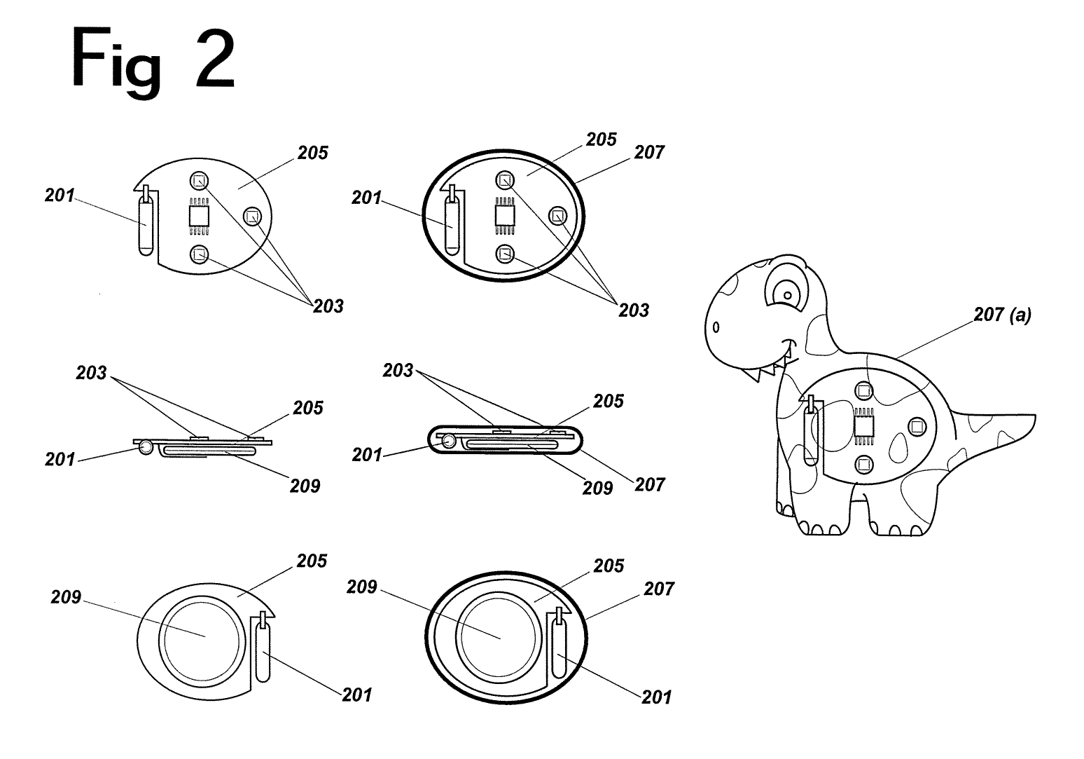

As shown in FIG. 2, the light module 101 comprises a sensor 201 and a light source 203. The sensor 201 and light source 203 may be constructed on a circuit board 205, it may be constructed on a circuit board with a processing unit, or be directly wired together. The sensor 201 is designed to detect a change in surroundings, a change in stability or a combination thereof and may be a motion sensor, a temperature sensor, a light sensor or any other sensor that monitors changes in surroundings. The sensor 201 triggers the light source 203.

The sensor 201, upon sensing a change in a change in surroundings, a change in stability or a combination thereof, triggers the light source 203 to illuminate. Should the sensor 201 be a motion sensor, upon detecting motion, the sensor triggers the light source 203 to illuminate for a predetermined length of time, usually approximately 20-30 seconds. The motion sensor may be any commonly used motion sensor such as a vibration sensor or reed switch. The light illuminates and stays illuminated for the time when the user should be lathering and rubbing their hands on the soap in order to wash their hands, often times, 20-30 seconds. When the light stops illuminating, it indicates that the user has properly washed their hands.

Should the sensor 201 be a temperature sensor, it may illuminate the light source 203 when the proper temperature for washing hands is met. Should the illumination occur at the proper temperature, the light source 203 will illuminate so long as the predetermined temperature is met. Also, it may illuminate for a predetermined length of time, so long as the predetermined temperature is met. Should the sensor 201 be a light sensor, it may illuminate the light source 203 when the sensor is exposed to light.

The light source 203 may be any commonly used light bulb including but not limited to a light emitting diode, organic light emitting diode, liquid crystal display or miniature incandescent bulb. The light source 203 may be comprised of a single light emitting diode or bulb or a plurality of them. The light source 203 may illuminate in a variety of colors, designs, patterns or shapes. The color, design, pattern or shape of the illumination may change depending on the variables from the sensor, i.e. the color may change if the temperature sensed is within a certain range. Also, the color, design, pattern or shape of the illumination may change depending on the amount of time the light source has illuminated 203 for.

The light module 101 has a battery 209 that powers it. The light module 101 is encapsulated by a barrier 207 made of plastic, rubber or other material so that it is waterproof. The light module 101 may be encapsulated by a barrier 207 in any shape. For example, the light module 101 may be encapsulated by a barrier 207 in the form of an animal, car, dinosaur, etc. so that after the soap element 103 is consumed and depleted, the light module 101 remains in that particular shape. An alternative embodiment of the barrier 207(a) is shown in FIG. 2 as a dinosaur. The barrier 207(a) remains after the soap element 103 is depleted, so that the barrier 207(a) is similar to a dinosaur inside an egg, with the egg being the illuminating bar of soap 100.

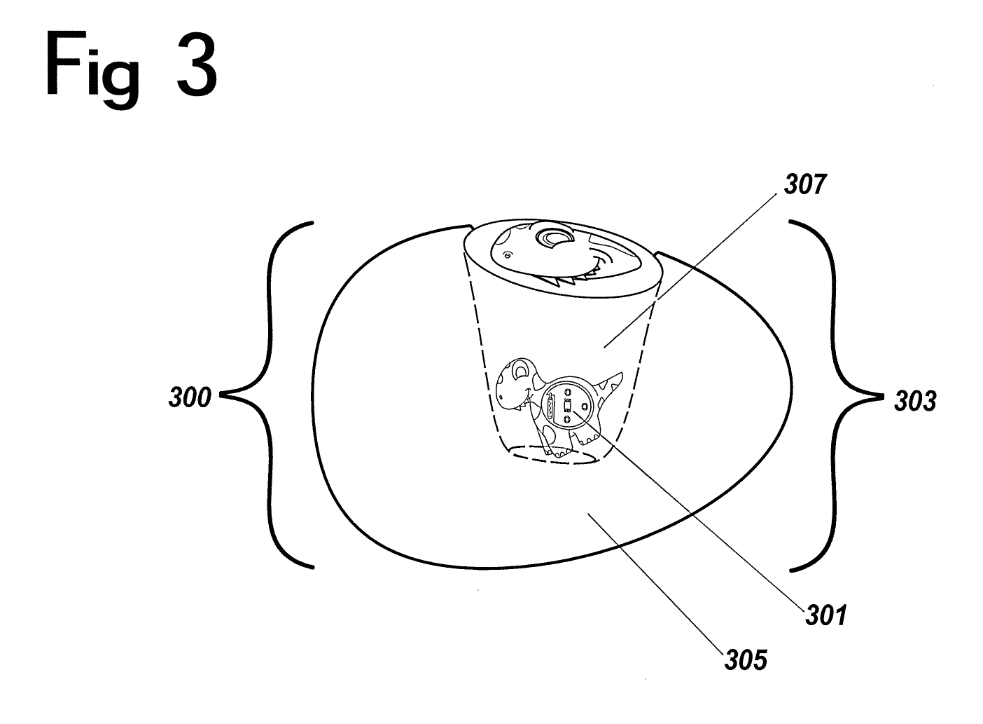

As shown in FIG. 3, the illuminating bar of soap 300 comprises a light module 301 and a soap element 303. The soap element 303 may comprise different layers 307 and 305. The different layers 307 and 305 may be made of different shapes so that the illuminated soap bar 100 may take multiple forms and shapes as the soap element 303 is depleted. The different layers may be made of different ingredients so that the different layers may be of different colors, textures or scents.

Thus, specific embodiments of an illuminated soap bar have been disclosed. It should be apparent, however, to those skilled in the art that many more modifications besides those already described are possible without departing from the inventive concepts herein. The inventive subject matter, therefore, is not to be restricted except in the spirit of disclosure herein. Moreover, in interpreting the specifications and claims, all terms should be interpreted in the broadest possible manner consistent with the context. In particular, the terms “comprises” and “comprising” should be interpreted as referring to elements, components, or steps in a non-exclusive matter, indicating that the referenced elements, components, or steps may be present, or utilized, or combined with other elements, components, or steps that are not expressly referenced.

What is claimed is:

1. An illuminating bar of soap comprising:
a light module and a soap element, wherein the light module is surrounded by the soap element.

2. The illuminating bar of soap of claim 1, wherein the light module comprises at least one sensor and at least one light source that is triggered by the at least one sensor.

3. The illuminating bar of soap of claim 2, wherein the at least one sensor is a motion sensor.

4. The illuminating bar of soap of claim 2, wherein the at least one sensor is a temperature sensor.

5. The illuminating bar of soap of claim 2, wherein the at least one sensor is a light sensor.

6. The illuminating bar of soap of claim 2, wherein the at least one light source is at least one light emitting diode powered by at least one battery.

7. The illuminating bar of soap of claim 2, wherein the at least one light source illuminates for a predetermined length of time.

8. The illuminating bar of soap of claim 1, wherein the light module is encapsulated by a barrier.

9. The illuminating bar of soap of claim 8, wherein the light module is encapsulated by the barrier to form a shape.

10. The illuminating bar of soap of claim 1, wherein the soap element is injection molded around the light module.

11. The illuminating bar of soap of claim 1, wherein the soap element is poured into a mold around the light module.

12. The illuminating bar of soap of claim 1, wherein the soap element that encapsulates the light module comprises a mixture of vegetable glycerin, essential oils and colored dye.

13. The illuminating bar of soap of claim 1, wherein the soap element that encapsulates the light module comprises a UV reactive pigment.

14. The illuminating bar of soap of claim 1, wherein the soap element that surrounds the light module comprises at least two separate layers.

15. The illuminating bar of soap of claim 14, wherein the at least two separate layers comprise different compositions of color, shape, scent and/or texture.

16. An illuminating bar of soap comprising:
a light module and a soap element, wherein the light module is surrounded by the soap element; wherein the light module comprises a sensor, a circuit board, and at least a single light source; and wherein when the sensor senses a change in surrounding, the sensor triggers the at least one light source to illuminate for a predetermined amount of time.

17. The illuminating bar of soap of claim 16, wherein the sensor is a motion sensor.

18. The illuminating bar of soap of claim 16, wherein the sensor is a temperature sensor.

19. The illuminating bar of soap of claim 16, wherein the sensor is a light sensor.

20. The illuminating bar of soap of claim 16, wherein the soap element comprises at least two separate layers.

21. The illuminating bar of soap of claim 16, wherein the light module is encapsulated by a barrier.

22. The illuminating bar of soap of claim 16, wherein the at least one light source is a light emitting diode powered by at least one battery.

23. A method of washing hands using an illuminating bar of soap, wherein the illuminating bar of soap comprises a light module surrounded by a soap element; wherein the light module comprises a sensor and at least one light source, the method comprising:
triggering the sensor causing the at least one light source to illuminate;
illuminating the at least one light source; and
washing the user's hands with the illuminating bar of soap, wherein the at least one light source stops illuminating when the user should stop washing the user's hands.

24. The method of claim 23, wherein the sensor is a motion sensor.

25. The method of claim 24, wherein the sensor triggers the at least one light source to illuminate for a predetermined length of time.

26. The method of claim 23, wherein the sensor is a temperature sensor.

27. The method of claim 26, wherein the sensor triggers the at least one light source to illuminate only if the temperate is at a predetermined value.

28. The method of claim 23, wherein the sensor is a light sensor.

29. The method of claim 28, wherein the sensor triggers the at least one light source to illuminate when the sensor is exposed to light.
